(19) United States
(12) Patent Application Publication
(10) Pub. No.: US 2011/0213140 A1
(43) Pub. Date: Sep. 1, 2011

(54) PROCESS FOR CONTINUOUS CATALYTIC ACETYLATION

(76) Inventors: Daniel Witte, Grenzach-Wyhlen (DE); Andreas Diener, Grossschirma (DE)

(21) Appl. No.: 13/056,326

(22) PCT Filed: Jul. 27, 2009
(86) PCT No.: PCT/EP09/05412

§ 371 Date: May 17, 2011

(30) Foreign Application Priority Data
Jul. 29, 2008 (DE) 10 2008 035 401.5

(51) Int. Cl. C08B 37/00

(52) U.S. Cl. 536/123.1

(57) ABSTRACT

In a process for continuous acetylation of polysaccharide, a pressure is to be established in a reactor chamber such that a boiling point of a reaction mixture corresponds to a desired reaction temperature and an exothermicity of the reaction is controlled by evaporative cooling.

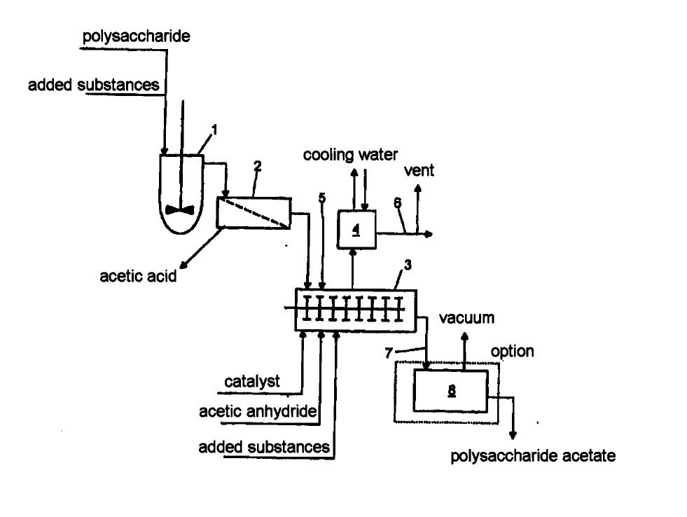

### BACKGROUND OF THE INVENTION

This invention relates to a process for continuous acetylation of polysaccharides.

DE 10 2005 001 802 A1 discloses a method for the continuous implementation of polymerization processes. In this method, the starting materials are introduced in liquid form into a backmixed mixing kneader having a certain length/diameter ratio. These starting materials are backmixed with already reacted product and at the same time the reacted product is continuously withdrawn from the mixing kneader.

Acetylating polysaccharides is well-known art. Conventionally, the polysaccharide to be reacted is contacted with a mixture of acetaldehyde and anhydrous acetic acid and also further additives in a stirred tank.

The acetaldehyde reacts with the polysaccharide to form polysaccharide acetate and acetic acid. Acetic acid is the solvent for the reaction product as well as the reaction product. Acetylation of the polysaccharide is generally complete, but partial acetylation is likewise possible according to this invention. In order that acetylation may proceed uniformly and quickly, the polysaccharide is inoculated by means of a catalyst. The catalyst is generally a strong acid. Additives are often added to function as the plasticizer of the polysaccharide and will usually co-react and the reaction products can then serve as plasticizers of the polysaccharide acetate.

The activity of the catalyst increases with temperature. In addition to catalyzing the acetylation, the catalyst modifies the polysaccharide and creates shorter molecules. The process is therefore characterized by exact catalyst dosage and temperature control, since the reaction is strongly exothermic.

In the batch mode of operation, this temperature control can be exerted through gradual metered addition of supercooled liquid reactants and of the catalyst to the polysaccharide mass. At the same time, some of the heat can be removed by the cooling jacket of the stirred tank. This process is very slow owing to the poor mixing performance of the stirred tank, and the tank has to have a very large volume to be able to accommodate the initially very lightweight polysaccharide (low bulk density).

In a conventional continuous operation of the same process, the cooling power has to be removed by the cooling surfaces of the continuous reactor. The required cooling surfaces per unit reactor volume which are needed are very large, making it very difficult to actualize large reactors in particular.

Numerous methods of acetylation are known. For instance, GB 969 711 shows a method for continuous acetylation of amylose. In this method, the process takes place at a particular temperature and at a particular pressure.

The problem addressed by this invention is that of providing a continuous process and corresponding apparatus whereby the acetylation may be completed with a very short residence in the reaction space at high conversion in order to minimize both the manufacturing costs of the reactor and the exposure time to the catalyst in order that undesired secondary reactions may be suppressed.

### SUMMARY OF THE INVENTION

The problem is solved when the polysaccharide is metered directly in fiber or powder form continuously into a reactor or is pre-mixed in pre-mixers with acetic acid/added substances and then is pumped or falls as a suspension into the reactor and a pressure in a reactor space being set such that a boiling point of a reaction mixture corresponds to a desired reaction temperature and any exotherm of the reaction is controlled via evaporative cooling.

Preferably, the polysaccharide and a portion of the liquid starting materials will be pre-mixed in an upstream assembly and fed as a suspension to a continuous reactor, for example a mixing kneader, by means of a suitable conveying element into the processing space of the reactor, wherein the suspension is under a set pressure corresponding to the boiling point of acetic acid at the desired processing temperature. The rest of the liquid starting material is supplied to the process by means of a conventional metering pump. Therefore, the acetic acid and to some extent the acetaldehyde also evaporates in portions, thereby remove from the reactor the excess energy arising out of the exotherm, and are withdrawn via one or more vapor domes on the reactor, condensed and returned wholly or partly into the process together with the liquid reactants and catalyst.

As a result of this form of process management, a local dilution of the mixture is formed in the return or introduction zone and promotes the suspension of the polysaccharide in the introduction zone, and this in turn speeds up the reaction, since the acetaldehyde gains easier access to the polysaccharide. When the polysaccharide mixture which is introduced into the reactor is present in fiber or powder form, the introduction member into the processing space is provided according to the present invention as a sluice.

If the polysaccharide is introduced into the processing space, which is under vacuum, in fiber or powder form, it has to be accepted that a large proportion of infiltrated air will end up in the processing space as part of the powder. This undesired introduction of infiltrated air into the processing space can be avoided if the polysaccharide is not metered into the processing space in the form of powder or fiber. Instead, the polysaccharide is suspended beforehand in sufficient anhydrous acetic acid. It is then pumped into a continuous sieving centrifuge or cutting mill which operates under the same pressure conditions as in the reactor, or separates the excess acetic acid back off. The suspension of solid material and acetic acid is then conveyed/pumped directly into the reactor or falls into it by gravitation.

The difficulties with continuous metering of the solid polysaccharide can be avoided by pre-mixing the reaction products to form a pumpable and hence distinctly better handleable suspension.

A further advantage of this invention concerns the cooling of the condensate. Temperature-controlled cooling water can be used, whereas in the conventional process supercooled liquids or solids have to be added to compensate the exothermic energy.

The process according to this invention makes it possible to control the residual acetic acid content in the polysaccharide acetate by specifically recycling only parts of the acetic acid and or via a downstream flash.

Since the acetic acid is solvent and reactant alike and generated as condensate in anhydrous form, the bleed stream not returned into the reactor can be reused directly in the pre-mixture.

The process according to this invention also makes it possible to adjust the residual acetic acid content of the polysaccharide acetate as desired. When too much acetic acid is present, a bleed stream or the entire stream of the condensate is withdrawn from the recycling circuit and removed from the system separately. Since this bleed stream is anhydrous, it can be reused directly or after conversion in acetaldehyde.

### BRIEF DESCRIPTION OF THE DRAWINGS

Further advantages, features and details of this invention will become apparent from the following description of a preferred exemplary embodiment and also from the drawing, which shows, in its single figure, a block diagram of a plant for carrying out the process of this invention.

### DETAILED DESCRIPTION

The process of this invention for continuous acetylation of polysaccharide starts in a pre-mixer 1, which is followed by a centrifuge 2. Thereafter, the product passes into a reactor 3, from which the product in turn transfers via a flash 7 into a vacuum evaporator 8, from which the end product is then discharged.

The process of this invention proceeds as follows:

The starting materials or portions of the starting materials, more particularly a polysaccharide and added substances, are metered continuously into the pre-mixer 1 and mixed therein to form a homogeneous mixture. Any excess acetic acid can be separated off mechanically when a centrifuge is used or else in some other way. But it is also possible to pump the suspension directly from the pre-mixer 1 into the reactor 3 or for it to fall into the reactor 3 via a vacuum sluice.

In the case of split metering, further portions of the split starting materials are fed directly into the reactor 3 in a continuous manner. A catalyst, acetaldehyde or further added substances can be concerned here.

Owing to the exothermic reaction, acetic acid and also acetaldehyde to some extent evaporates, condenses in a condenser 4 and is in part 5 or as a whole fed back into the reactor or removed from the system at 6. The off-gas stream will possibly be connected to a vacuum plant in order that the product temperature (evaporation temperature) in the reactor may be policed.

Optionally, the polysaccharide acetate is introduced via the flash 7 into a vacuum evaporator 8 in which the remaining acetic acid and the acetaldehyde is removed. Polysaccharide acetate is discharged.

1-20. (canceled)

21. A process for continuous acetylation of polysaccharide comprising metering the polysaccharide in fiber or powder form, directly and continuously into a reactor (3) or pre-mixed in pre-mixers (1) with acetic acid/added substances and then fed as a suspension into the reactor (3), wherein pressure in a reactor space is set such that a boiling point of a reaction mixture corresponds to a desired reaction temperature and any exotherm of the reaction is controlled via evaporative cooling.

22. The process according to claim 21, wherein only some of the acetic acid is pre-mixed with the polysaccharide, while the rest is added directly into the reactor (3).

23. The process according to claim 21, wherein the added substances are catalysts and/or plasticizers/fillers, which in the pre-mixing step (1) are added directly into the reactor (3) or at both places.

24. The process according to claim 21, wherein vaporized gas is condensed and the liquid condensate is wholly or partly added back to the reaction mixture for evaporative cooling and/or for dilution.

25. The process according to claim 24, wherein a cooling medium is cooling water and the condensate is generated as a liquid at the same pressure as the reactor (3) is operated.

26. The process according to claim 21, wherein the polysaccharide or a mixture is introduced into the reaction space of the reactor (3) by means of a vacuum- or pressure-tight sluice.

27. The process according to claim 21, wherein the suspension of polysaccharides and acetic acid/added substances is fed to a continuous sieving centrifuge (2) which is under vacuum and removes the excess acetic acid again before forwarding the solid material to the reactor (3).

28. The process according to claim 21, wherein the acetylation is one of full or partial.

29. The process according to claim 21, wherein the the added substances during the acetylation undergo no chemical-physical change or chemical transformation.

30. The process according to claim 21, wherein the polyacetate mass is partially or completely freed of the unconverted acetic acid by a downstream flash (7).

31. The process according to claim 30, wherein the polysaccharide acetate mass is discharged from the reactor (3) by a screw.

32. The process according to claim 30, wherein the polysaccharide acetate is freed of the residual acetic acid by a subsequent vacuum evaporation (8).

33. The process according to claim 21, wherein the added substance functions as a plasticizer of the polysaccharide and after acetylation an acetate of the substance acts as a plasticizer of the polysaccharide acetate.
